(19) United States
(12) Patent Application Publication
(10) Pub. No.: US 2017/0185849 A1
(43) Pub. Date: Jun. 29, 2017

(54) APPARATUS AND METHOD FOR MONITORING PREMISES

(71) Applicant: Wal-Mart Stores, Inc., Bentonville, AR (US)

(72) Inventors: Donald R. High, Noel, MO (US); David C. Winkle, Bella Vista, AR (US); Michael D. Atchley, Springdale, AR (US)

(21) Appl. No.: 15/388,387

(22) Filed: Dec. 22, 2016

Related U.S. Application Data
(60) Provisional application No. 62/387,483, filed on Dec. 23, 2015.

(51) Int. Cl. G06K 9/00; H04N 13/02; H04N 9/04; H04N 7/18; H04N 5/33; B64C 39/02; G06K 9/66

(52) U.S. Cl. CPC G06K 9/00771; B64C 39/024; H04N 13/0203; G06K 9/66; H04N 7/185; H04N 5/33; H04N 9/04; B64C 2201/127

(57) ABSTRACT

Systems, apparatuses and methods are provided herein for providing monitoring premises. In one embodiment, a system for monitoring premises comprises: an unmanned aerial vehicle (UAV) comprising a three dimension (3D) scanner, a baseline model database, and a control circuit comprising a communication device for communicating with the UAV. The control circuit being configured to: instruct the UAV to travel to a monitored premises and perform a 3D scan with the 3D scanner to obtain a 3D point cloud of the monitored premises, compare a current state of the one or more features in the 3D point cloud of the monitored premises with a baseline state in a baseline state model, and identify a deviation of the current state of the one or more features of the monitored premises from the baseline state.

### CROSS-REFERENCE TO RELATED APPLICATIONS

This application claims the benefit of U.S. Provisional Application No. 62/387,483, filed Dec. 23, 2015, which is incorporated herein by reference in its entirety.

### TECHNICAL FIELD

This invention relates generally to unmanned aerial systems.

### BACKGROUND

Conventionally, security monitoring systems include cameras or sensors installed at monitored premises. Such systems typically require the purchase of various hardware equipment and professional installation services.

### BRIEF DESCRIPTION OF THE DRAWINGS

Disclosed herein are embodiments of apparatuses and methods for monitoring premises. This description includes drawings, wherein:

FIG. 1 is a system diagram of an overall system in accordance with several embodiments.

FIG. 2 is a flow diagram of a method in accordance with several embodiments.

FIG. 3 is a block diagram of a system in accordance with several embodiments.

FIG. 4 is a process diagram in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for monitoring premises. In some embodiments, a system for monitoring premises comprises: an unmanned aerial vehicle (UAV) comprising a three dimension (3D) scanner, a baseline model database, and a control circuit comprising a communication device for communicating with the UAV. The control circuit being configured to: instruct the UAV to travel to monitored premises and perform a 3D scan with the 3D scanner to obtain a 3D point cloud of the monitored premises, retrieve a baseline state model of the monitored premises from the baseline model database, the baseline state model comprises a baseline state of one or more features of the monitored premises, compare a current state of the one or more features in the 3D point cloud of the monitored premises with the baseline state of the one or more features in the baseline state model, and identify a deviation of the current state of the one or more features of the monitored premises from the baseline state.

Sometimes, property owners may wish to monitor and/or assess security vulnerabilities of their properties. Some owners may only want a short term home security monitoring. For example, an owner may want peace of mind that someone is watching their property while they are away on vacation. However, typical security systems require up-front investment in equipment purchase and installation service.

In some embodiments of the systems, methods, and apparatuses described herein, data collected by UAVs may be analyzed to assess security elements of a location. In some embodiments, the system may perform measurements and analysis one or more of satellite images, 3D scans, and UAV captured images to look for security considerations such as exterior lighting, property egress/ingress, fields of view, and fence lines. Measurements, distances, dimensions (3D scans/point clouds), times, GPS locations and other data may be stored and/or associated with geospatial information (GIS) in the system for analysis.

In some embodiments, UAVs may be used for on-going surveillance of premises. One or more UAVs may be assigned to watch a building or premises over an extended period of time. A UAV may capture images and videos at monitored premises. The collected data may be used to measure environmental parameters, count people/cars, check doors, windows, gates, lights, vehicles, equipment, etc. The system may then compare expected values to measured values to detect potential security concerns. A UAV enabled security monitoring service may provide the flexibility of minimal commitment and capital investment, while requiring no specific skill to operate. A UAV enabled security monitoring system may also provide enhanced features such as remote control, on-going analysis, dynamic re-positioning/configuration, and the ability to operate in areas where permanent cameras cannot be easily installed.

In some embodiments, the system may use a team of UAVs to perform joint surveillance of multiple properties while keeping the surveillance information and captured data separate for each property. A central computer may coordinate semiautonomous flights of multiple UAVs at one or more times to optimize coverage for multiple monitored premises.

The system may perform image analysis to identify security issues from the sky-view surveillance video and images. In some embodiments, one or more UAVs may be assigned to watch a building or property for on-going/drone-is-resident type surveillance. The UAVs may capture day/night images and/or videos, perform 3D scans, measure environmental parameters, count people/cars, check doors, windows, gates, lights, vehicles, equipment, etc. at the monitored premises.

In some embodiments, the central computer system may act as a watch commander and coordinate multiple UAVs on duty shifts. The UAVs may be rotated in and out of duty automatically for charging and/or maintenance as needed. In some embodiments, the system may perform an initial survey of monitored premises. An analysis based on the initial survey may be used to optimize the selection of data capture positions such that the captured may be completed in the shortest time and/or with the least number of UAVs. Watch zones may be mapped out to include no-watch or no-fly zones. No-watch zones may be established to protect the privacy of others. No-fly zones may exclude risk-areas such as proximity to people or power lines. In some embodiments, the system may automatically navigate away from no-fly zones and disable cameras around no-watch zones. The coordinates associated with no-fly zones may be maintained by the central computer and used for determining routes for UAVs. Cameras may be selectively disabled by an on-board control system based on the global positioning system (GPS) coordinates of the UAV. In some embodiments, the UAVs may further include a directional microphone for capturing sound.

In some embodiments, the system may capture images (including night and day images), sound, sensor input, and record/log results to generate alerts/status updates for customer playback or review. The captured images may be compared, and changes or absence of expected change may be detected to generate an alert. For example, the system may detect vehicles that have not moved for extended periods of time and/or detect visible damage to fencing.

In some embodiments, 3D scans of the premises may be used to measure changes in distance or dimension of features of the premises and compared to assessment data. Alerts may be created when relevant changes are detected. For example, the gaps in doors and windows may be measured to determine whether doors or windows are left ajar. In some embodiments, the system may provide remote access to UAV mounted cameras and provide limited remote control of the UAVs to customers to allow customers to direct the view of the camera towards areas of interest.

In some embodiments, the system may assess security elements by analyzing one or more of: satellite images, 3D scans, and aerial images, to looks for security considerations such as exterior lighting, property egress/ingress, fields of view, fence lines, etc. to generate a security improvement recommendation for the premises. Properly placed lighting is generally a deterrent to unauthorized entry to property and buildings. The system may analyze images captured over time to look for shadows and areas where illumination is insufficient and make recommendations for additional lighting. In some embodiments, the collected data may be analyzed to determine property ingress/egress lines such as roads and paths compared to the location of doors, windows, stairs and other elements. For example, the system may determine whether access for fire or emergency vehicles is sufficient under a variety of situations and traffic patterns. The system may further determine whether access (e.g. a path, a route through alleys or woods.) is concealed from a ground perspective and recommend landscaping changes to reveal the access way.

In some embodiments, the system may also compare property lines to fence lines to determine fence continuity, condition, and completeness. Fencing may be analyzed for obstruction or damage through model comparison and pattern recognition. Damaged or missing sections may be identified by the system. Fence lines may further be compared with access, property lines, and other survey data to identify potential needs for additional fencing, locks, gates, or other barriers.

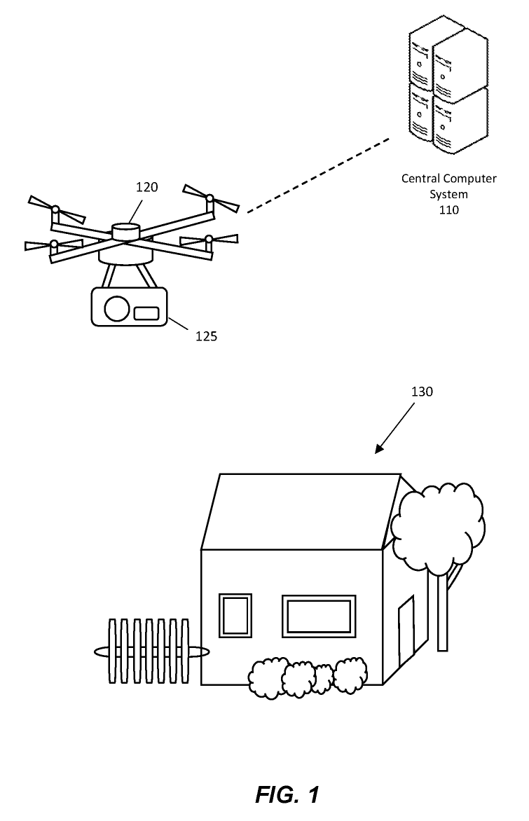

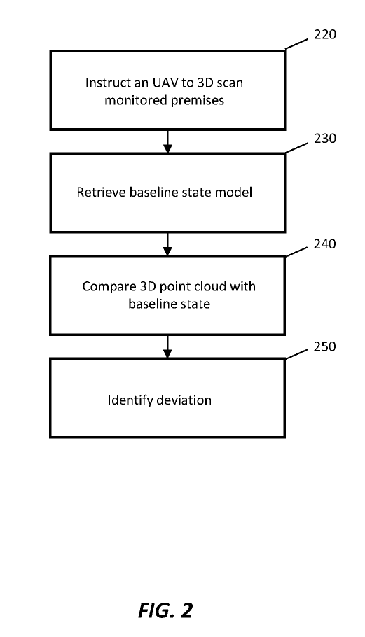

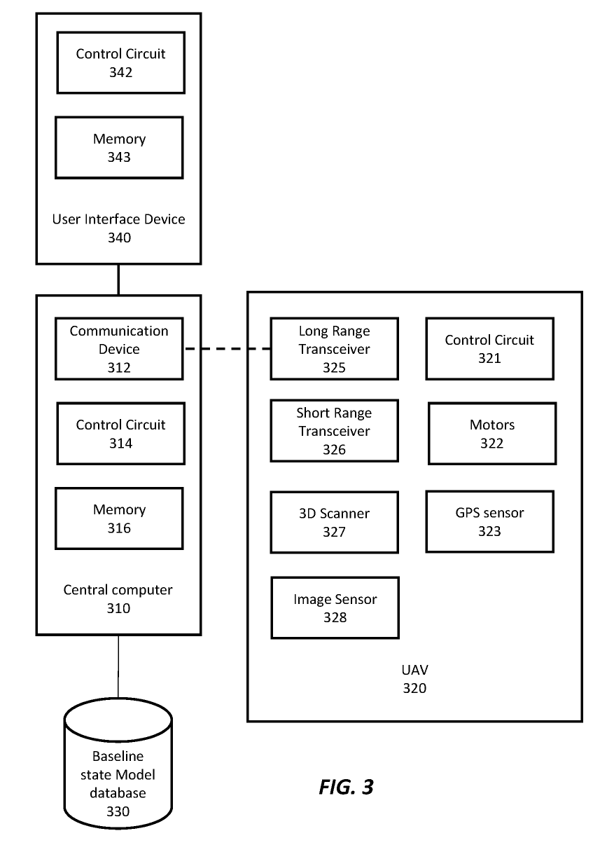

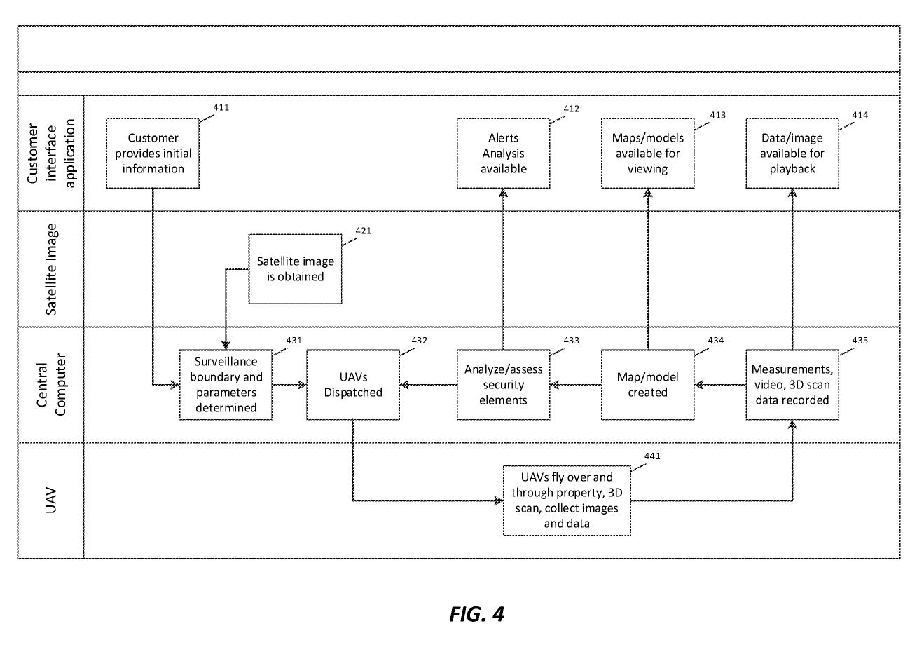

Referring now to FIG. 1, a system for monitoring premises according to some embodiments is shown. The system includes a central computer system 110 configured to communicate with a UAV 120 including a sensor device 125 configured to obtain data from the premises 130 which may include one or more structures 132 and open areas 134. The central computer system 110 may comprise a control circuit, a central processing unit, a processor, a microprocessor, and the like and may be one or more of a server, a central computing system, a retail computer system, a personal computer system, and the like. Generally, the central computer system 110 may be any processor-based device configured to communicate with UAVs and process 3D and image data. The central computer system 110 may include a processor configured to execute computer readable instructions stored on a computer readable storage memory. The central computer system 110 may generally be configured to cause the UAV 120 to travel to monitored premises 130 to gather a set of data and compare the gathered data with a baseline condition model associated with the premises to detect potential security concerns. Generally, the central computer system 110 may perform one or more steps in the methods and processes described with reference to FIGS. 2 and 4 herein. Further details of a central computer system 110 according to some embodiment is provided with reference to FIG. 3 herein.

The UAV 120 may generally comprise an unmanned aerial vehicle configured to carry a sensor device 125 in flight and fly near the premises 130 for data capture. In some embodiments, the UAV 120 may comprise a multicopter configured to hover at and/or near the monitored premises 130. In some embodiments, the UAV may be a quadcopter, or hexacopter, octocopter, etc. In some embodiments, the UAV 120 may comprise a communication device configured to communicate with the central computer system 110 before and/or during flight, a GPS receiver configured to provide geolocation information of the UAV 120, and a control circuit configured to control the motors driving a plurality of propellers to navigate the UAV 120. In some embodiments, the UAV 120 may include other flight sensors such as optical sensors and radars for detecting obstacles in the path of flight to avoid collisions. While only one UAV 120 is shown, in some embodiments, the central computer system 110 may communicate with and/or provide instructions to a plurality of UAVs. In some embodiments, two or more UAVs may be deployed to monitor the premises 130 at the same time and/or in shifts.

The sensor device 125 may comprise one or more sensors for capturing data at the monitored premises 130. The sensor device 125 may comprise one or more of a 3D scanner, an image sensor, a sound sensor, a light sensor, a visible spectrum camera, a thermal image sensor, a night vision camera, etc. In some embodiments, one or more sensors may be coupled to an actuator that pivots and/or rotates the sensor relative to the body of the UAV 120. The sensor device 125 may be one or more devices attached to the UAV's body through one or more attachment means and/or may be integrated with the body of the UAV 120. While the sensor device 125 unit is shown to be attached to the bottom of the UAV 120 in FIG. 1, in some embodiments, sensors may be attached to different portions of the UAV (e.g. top, wing, landing gear, etc.). In some embodiments, the sensor device 125 may be a standalone device for recording data that may operate independently when detached from the UAV 120. In some embodiments, the sensor device 125 may be at least partially integrated with the controls of the UAV 120. In some embodiments, the sensor device 125 and the UAV may share the same one or more of: a control circuit, a memory storage device, and a communication device. In some embodiments, the sensor device 125 may be communicatively coupled to the control circuit of the UAV 120 and configured to receive commands from the control circuit of the UAV 120 (e.g. began captured, end captured, rotate, etc.). In some embodiments, the sensor device 125 may comprise a communication device for independently communicating with the central computer system 110. Herein, a UAV may refer to a UAV 120 with or without a sensor device 125 attached to and/or integrated with the UAV. Further details of a UAV 120 according to some embodiments is provided with reference to FIG. 3 herein.

The premises 130 may generally be any premises including buildings and/or open areas. In some embodiments, the monitored premises 130 may be real-estate owned, rented, and/or managed by a retail entity or customer. While single residence residential premises is shown in FIG. 1, in some embodiments, the premises may correspond to one or more of a multi-residence residential premises (e.g. condos, apartments, duplexes, multiplexes) and non-residential premises (e.g. office building, retail building, storage facility, distribution center, factory, farm, ranch, etc.). The premises 130 may include one or more structures 132 such as a house, a shed, a garage, a car port, a patio, a gazebo, etc. that may be scanned from the exterior of the structures. The premises 130 may further include one or more open areas 134 such as one or more of front yard, back yard, side yard, drive way, parking lot, road way, etc. The UAV 120 may capture data from one or both of structures and open areas at the premises and relay the captured data back to the central computer system 110. In some embodiments, the captured data may be transmitted substantial real-time back to the central computer system 110.

Referring now to FIG. 2, a method of monitoring premises is shown. In some embodiments, the steps shown in FIG. 2 may be performed by a processor-based device, such as the central computer system 110 shown in FIG. 1, the control circuit 314, the control circuit 342, and/or the control circuit 321 described with reference to FIG. 3 below. In some embodiments, the steps may be performed by one or more of a processor at the central computer system, a processor of a user device, a processor of a UAV, and a processor of a sensor device carried by the UAV.

In step 220, the system instructs a UAV to perform a 3D scan at a monitored premises. In some embodiments, prior to step 220, a request to monitor the premises location may be received via a user interface device such as an in-store kiosk, a web-accessible user interface, a customer service counter, a mobile application, a computer program user interface, and a store customer service associate terminal, etc. The security monitoring request may include premises location information such as an address and/or a coordinate. In some embodiments, the user interface may display a map, a satellite view, and/or a street view to the user to confirm the location and/or boundary of the premises. In some embodiments, the systems may further be configured to verify that the user has the authority to request monitoring of the indicated premises. For example, a user interface device and/or a store associate may verify that the entered premises information corresponds to a residential or commercial property owned, rented, and/or managed by the customer by scanning one or more of the customer's government issued identification (e.g. driver's license, passport, etc.), the customer's bank card (e.g. credit card, debit card, etc.), the customer's utility bills, etc. In some embodiments, the system may also display configurable access permissions to a user and receive the user's selection of permissions. For example, the system may display one or more areas to monitor (e.g. front yard, back yard, house, detached garage, store shed, etc.), one or more types of data to gather (e.g. 3D model, colored images, thermal images, etc.), and one or more capture time frames (e.g. 2 pm-5 pm, weekdays only, etc.) for user selection. In some embodiments, some data types and/or areas may be mandatory for enrolling in the security monitoring program. In some embodiments, the customer may selectively authorize the collection of one or more types of data from one or more areas. In some embodiments, the user may further authorize and configure the schedule for repeated periodic monitoring (e.g. hourly, daily, etc.) and/or the duration of the monitoring service subscription (e.g. one weekend, one month, etc.).

The system may instruct a UAV to travel to the premises location based on the security monitoring request and configuration. For example, a user may selectively configure how often the premises should be visited by a UAV (e.g. hourly, every three hours, daily). In some embodiments, a user may selectively enable and disable security monitoring based on their schedule. In some embodiments, the system may use the GPS location information of a user device to determine whether a user associated with the premises is at home, and only have a UAV visit the premises when the user is away from home. In some embodiments, a monitoring trip may be initiated on-demand by a user. For example, a user may use a web-based and/or app-based user interface to request the dispatch of a monitoring UAV. In some embodiment, the UAV may perform security monitoring of the premises during a package delivery trip. For example, a UAV may collect security monitoring related data when it delivers an item to the premises location that had previously enrolled in the security monitoring program. In another example, a delivery UAV may perform security monitoring of premises locations that are near its route to and from one or more delivery destinations.

In some embodiments, the system may determine GPS coordinates of the monitored premises based on the premises location information submitted with a monitoring request. In some embodiments, the system may use satellite image information to determine the boundary of the premises. In some embodiments, a central computer may further determine a route for the UAV to travel from a dispatch location to the monitored premises and communicate the route to the UAV. The route may be determined based on avoiding no-fly zones (e.g. government regulation flight restricted zones, tall buildings, power lines, etc.) on the path. In some embodiments, the central computer may maintain communication with the UAV to assist in the navigation as the UAV travels to the monitored premises. In some embodiments, the system may further determine a set of data to collect based on the monitoring request and/or a previously established baseline condition model and communicates information relating to data to be collected to the UAV. In some embodiments, the system may select a UAV from a plurality of UAVs based on or more of monitored premises location, UAV location, UAV condition (e.g. charge state, range, scheduled task, etc.), and premises type (e.g. single residence residential premises, commercial premises, etc.).

In some embodiments, the central computer system may maintain communication with the UAV as the UAV performs a 3D scan at the monitored premises. In some embodiments, the central computer may instruct the UAV to activate one or more sensors such as one or more of a 3D scanner, an image sensor, a sound sensor, a thermal sensor, etc. at one or more locations and/or one or more orientations at the monitored premises. In some embodiments, the UAV may be preloaded with a set of instructions for gathering data and be configured to determine where and how to collect at least some data in the data set at the premises. In some embodiments, the system may determine where and how to capture data at the monitored premises based on a previous baseline survey of the premises. For example, the system may determine one or more locations for data capture based on a previous survey of the premises such that a desired data set is gathered with minimal scans and data capture time. In some embodiments, a UAV may hover at one or more locations such that the 3D scanner on the UAV may obtain scans from different angels. In some embodiments, the system may use data captured by the UAV to determine additional data to collect. For example, the system may determine additional locations and/or angles to acquire the desired data set. For example, if a feature relevant to security monitoring is obstructed by vegetation, the system may determine a different capture location to obtain an image and/or 3D of the relevant feature. In some embodiments, the central computer may instruct the UAV to land to collect one or more types of data in the data set. For example, a UAV may land at a designated location on the premises prior to beginning a 3D scan.

In some embodiments, the system may form a 3D point cloud model of the premises based on the 3D data collected by the 3D scanner of the UAV in step 220. In some embodiments, the 3D scanner on the UAV may comprise a large volume 3D laser scanner such as a Faro Focus3D scanner. In some embodiments, the scanner may be configured to measure distances between the scanner and a plurality of points in its surrounding area to obtain a 3D point cloud of its surrounding. The 3D scanner may include an actuator for pointing the laser at different angles around the scanner. In some embodiments, the distance measurement may be obtained from repeated measurements of reflected laser at different angles. In some embodiments, the system and/or the 3D scanner may stitch point clouds captured at different locations to form a 3D point cloud of the premises. The stitching may be based on the location of the 3D scanner at the time of the capture. In some embodiments, the location of the 3D scanner may be based on a GPS and/or cellular receiver associated with the 3D scanner. In some embodiments, the 3D point cloud model of the premises may correspond to a high precision (e.g. centimeter, millimeter, or higher resolution and accuracy) and at-scale virtual 3D model of the monitored premises.

In some embodiments, the system may also be configured to determine areas and/or directions to avoid. For example, the UAV may be instructed to prevent sensors from gathering data from specified areas and/or directions such that data from neighboring premises are not collected. In some embodiments, the system may be configured to automatically purge data collected from neighboring premises. For example, the system may determine a boundary of the monitored premises and avoid collecting data from structures and views outside of the monitored premises.

In some embodiments, while a UAV is at monitored premises, a user associated with the premises may be given at least partial control of the UAV to manually direct the monitoring of the premises. For example, the system may notify a user when a UAV is on-premises via a user interface. The user may control the direction of a camera on the UAV and/or select UVA hover locations to monitor the premises via the user interface. The system may relay the images and/or sound captured by the UAV to the user via the user interface substantially in real-time.

In step 240, the system compares a 3D point cloud model of the monitored premises with a baseline state model. The system may compare a current state of one or more features in the 3D point cloud of the monitored premises captured in step 220 with the baseline state of the one or more features of the monitored premises in the baseline state model. The baseline state model may be retrieved from a baseline state model database storing baseline state models of one or more monitored premises locations. A baseline state model generally provides information on the expected baseline state of the monitored premises. In some embodiments, the baseline state model may include a baseline 3D point cloud model end one or more of colored images, thermal images, and night-vision images of the monitored premise. In some embodiments, the baseline state model may identify one or more security related features of the monitored premises and specify a baseline state for each security related features. In some embodiments, the baseline state model may further include deviation thresholds for generating security alerts for one or more features.

In some embodiments, the baseline state model may comprise and/or be based on a 3D point cloud of the monitored premises captured at an earlier time and/or attributes derived from such 3D point cloud. In some embodiments, the baseline state model may further be determined based on other types of data such as images captured at the premises, customer's profile information, customer inputted information, and premises neighborhood/geographic information. In some embodiments, when the system first receives a monitoring request, the system may initiate an initial survey of the premises to establish a baseline condition model for the premises. The initial survey may be performed by a ground and/or a UAV carried 3D scanner configured to obtain a 3D point cloud of the premises. In some embodiments, the initial survey may also include data collected by an image sensor such as a camera and/or a thermal sensor. In some embodiments, the system may analyze the 3D point cloud and/or captured images to identify one or more features at the monitored premises, determine a baseline state for one or more features, and/or perform one or more measurements. One or more of the 3D point cloud, the captured images, the identified features, the baseline states, and the measurements may be stored as part of the baseline state model. In some embodiments, the system may instruct the owner/occupier/manager to prepare the premises for the initial security survey. For example, the system may instruct that all windows and doors of the premises be closed and all security lights and cameras be turned on prior to the initial security survey. In some embodiments, the system may instruct one or more UAVs to perform one or more initial surveys to establish the baseline condition of the premises. In some embodiments, the initial survey includes data captured by other types of sensors such as a colored image sensor, a thermal sensor, night vision cameras, etc. The system may be configured to identify one or more features and determine one or more baseline and current states based further on colored images and/or thermal images captured at the monitored premises. In some embodiments, the system may be configured to generate security improvement recommendations based on analyzing the initial security survey. For example, the system may recommend the installation of lights and/or fencing based on the initial security survey.

In some embodiments, the baseline state 3D point cloud of the premises location may be directly compared with the 3D point cloud captured in step 220 to detect differences between the 3D point cloud models. In some embodiments, the system may identify one or more features in the 3D point cloud captured in step 220 and compare the states of the identified features with the baseline states of the corresponding features in the baseline state model.

In some embodiments, the system may be configured to identify one or more of a door, a gate, a window, an electrical box, a security camera, a light fixture, a door hinge, a door knob, a window panel, patio furniture, etc. based on the 3D point cloud and/or other captured data such as colored images and thermal images. Features may be identified based on one or both of data captured during the baseline survey and during a subsequent monitoring trip. The one or more features may be identified using object recognition algorithms and may be based on one or more of the object's color, shape, dimension, location, temperature, and identifying marking. In some embodiments, one or more features may be identified based on an active signal transmitter and/or a passive radio frequency identity (RFID) tag. In some embodiments, the system may compare portions of the 3D model and image data with a database of known features. The database of known features may comprise characteristics of objects including one or more of color, shape, dimension, likely location, likely temperature, identifying marking, 2D image, and 3D model associated with the feature. In some embodiments, the system may be configured to identify one or more of a wall, a yard, a gate, a door, a window, a planter, a roof section, a gutter, a pillar, a beam, a fence, a furniture, a security device, vegetation, and the like. Generally, a feature may be any identifiable object and/or structural element. In some embodiments, the features may further include environmental conditions such as shadows, shades, puddles, snow accumulations, etc. In some embodiments, the system may allow for manual correction of the identified objects either by associates and/or customers associated with the monitored premises.

In some embodiments, a baseline or current state of a feature may correspond to one or more of a location, a presence, an appearance, an orientation, etc. of a feature. In some embodiments, the system may determine a state of one or more features in the captured 3D point cloud and compare the identified feature and state with the corresponding feature in the baseline model location. By comparing the current state of a feature with a baseline state, the system may identify security concerns by detecting the differences in the state of the feature. For example, with the comparison, the system may identify whether any door hinges or window panels has been removed or damaged. In another example, the system may identify whether the direction of a security camera has been altered. In some embodiments, the state of a feature may corresponds to measurements taken based on the 3D point cloud model. For example, the system my measure one or more of a gap width between a door and a door frame, a gap width between door panels, a gap width between a window and a window frame, and a gap width between window panels. The baseline model may specify a baseline state gap width between a door and a door frame, and the system may measure the current gap width of the door and the door frame in the capture 3D point cloud model and compare the measurement with the baseline state gap width. In some embodiments, the system may compare a captured thermal map with a baseline state thermal map of the premises to determine whether a human is present at the premises and/or whether a heater, an air conditioning unit, an oven, and/or a stove has been left on.

In some embodiments, the system may determine what to look for in the captured 3D point cloud model and/or images based on the baseline state model. In some embodiments, the baseline state model may provide locations and/or identifying characteristics of security related features at particular premises, and the system may use that information to isolate one or more features in the captured 3D point cloud and/or images for analysis. For example, the baseline state model may identify the locations of glass window panels, security cameras, locks, etc., and corresponding locations in captured 3D point cloud may be analyzed for the state of a feature matching the shape, color, location, etc. of the expected feature. In another example, the baseline state model may specify the locations and the expected width of one or more door or window gaps, and the system may measure the width of gaps at the corresponding locations in the captured 3D point cloud to determine a current state of the feature.

In some embodiments, the UAV may communicate with stationary security devices at the premises to monitor the premises. In some embodiments, the UAV further comprises a short-range wireless communication device configured to communicate with one or more stationary devices on the monitored premises. The one or more stationary devices may comprise one or more of a door sensor, a window sensor, a motion sensor, a security camera, a gas sensor, and an appliance. The UAV may ping and/or wakeup one or more of the stationary devices to receive a data reading from each of the connected devices. The baseline model may further include baseline states for the one or more devices. The system may further compare data received from the stationary device(s) with the baseline state to determine deviations from the baseline state and/or generate security alerts. For example, the short range transceiver of the UAV may detect that one or more of a door sensor, a window sensor, a motion sensor, a security camera, a gas sensor, and an appliance that should be on is offline and/or turned off. The status of the stationary devices may be report to the central computer system and/or the user.

In step 250, the system identifies a deviation in the current state of one or more features of the monitored premises from the baseline state. In some embodiments, with the comparison in step 204, the system may identify misplaced, missing, and/or, altered features, and/or unexpected objects. In some embodiments, the system may determine that an object's orientation and/or a gap between two objects deviates from the baseline state. Generally, the system may detect deviations of the current state of one or more features from a baseline state specified in the baseline model.

In some embodiments, after a deviation is detected, the system may determine whether the deviation is relevant to security concerns and/or exceeds a threshold for generating an alert. For example, the system may be configured to ignore any deviations in the size and shape of vegetation around the house and/or movements of objects resembling a household pets. In some embodiments, the system may determine whether deviation in the door or window gap may be attributed to temperature changes or exceeds a threshold indicating that intentional tempering has likely occurred. In some embodiments, if the deviation is determine to be relevant to security concerns and/or exceeds a threshold deviation value, a system may generate a security alert to a user associated with the premises. The security alert may be provided to a user via a text message, an email message, a phone call, a mobile application, a web-accessible user interface, and the like. In some embodiments, the system may further be configured to alert a security personnel to investigate the deviation.

In some embodiments, after receiving a security alert, the user may use a user interface to indicate that the security alert should be investigated or ignored. For example, the system may generate an alert when a door to a shed is left open, and the user may indicate that the state of the door to the shed should be ignored as it is often left open by the owner of the house. The system may be configured to update the baseline state model based on user feedback. In another example, the system may generate an alert for a broken window, and the user may indicate that they do not intend to fix the window immediately and the system should ignore that window for a set period of time. In yet another example, the system may generate an alert when an unknown car is parked on the driveway. The user may indicate that the car is new to the household via the user interface and no further alerts should be generated for that car. Generally, user feedback may be used to determine the types of features and deviations to detect and/or ignore and/or determine the deviation threshold for generating a security alert. The system may be configured to update the baseline model accordingly.

In some embodiments, the system may generates a security recommendation based on the data collection performed in step 220 and/or an initial security survey. For example, the system may detect a dark corner that may be of security concern to the home owner, and recommend the installation of an additional outdoor light and/or camera at the location.

Referring now to FIG. 3, a block diagram of a system for monitoring premises is shown. The system includes a central computer 310, a UAV 320, a baseline state model database 330, and a user interface device 340.

The user interface device 340 comprises a control circuit 342 and a memory 343. The user interface device 340 may be one or more of a kiosk, an in-store terminal, a computer accessing a web site, a computer running a program, a mobile device running a mobile application, etc. The control circuit 342 may be configured to execute computer readable instructions stored on a memory 343. The computer readable storage memory 343 may comprise volatile and/or non-volatile memory and have stored upon it a set of computer readable instructions which, when executed by the control circuit 342, causes the control circuit 342 to provide an user interface to a user and exchange information with the central computer 310 via the user interface. The user interface device 340 may further comprise one or more user input/output devices such as a touch screen, a display, a keyboard, etc. that allows a user to enter premises location and/or authentication information. The user interface device 340 may further allow the user to receive and view alerts generated by the central computer 310 and/or partially control UAV(s) monitoring premises associated with the user. In some embodiments, the user interface device 340 may be owned and/or operated by a customer and/or a retail entity. The user interface device 340 may further include a network interface for communicating with the central computer 310 via a network such as the Internet and/or a store's private network. In some embodiments, the user interface device 340 may further include a scanner and/or reader for scanning an image, an optical code, a magnetic trip, an integrated circuit (IC) chip, and/or a RFID tag on one or more of the customer's government issued identification (e.g. driver's license, passport, etc.), the customer's bank card (e.g. credit card, debit card, etc.), and the customer's utility bills for identity verification.

The central computer 310 comprises a communication device 312, a control circuit 314, and a memory 316. The central computer 310 may be one or more of a server, a central computing system, a retail computer system, and the like. In some embodiments, the central computer 310 may be the central computer system 110 in FIG. 1. In some embodiments, the central computer 310 may comprise a system of two or more processor-based devices. The control circuit 314 may comprise a processor, a microprocessor, and the like and may be configured to execute computer readable instructions stored on a computer readable storage memory 316, The computer readable storage memory 316 may comprise volatile and/or non-volatile memory and have stored upon it a set of computer readable instructions which, when executed by the control circuit 314, cause the system to instruct the UAV to travel to monitored premises to gather data, and compare the collected data to a baseline state model in the baseline state model database 330 to detect deviations from the baseline state model. Generally, the computer executable instructions may cause the control circuit 314 of the central computer 310 to perform one or more steps in the methods and processes described with reference to FIGS. 2 and 4 herein.

The central computer 310 may be coupled to a baseline state model database 330 via a wired and/or wireless communication channel. In some embodiments, the baseline state model database 330 may be at least partially implemented with the memory 316 of the central computer 310. The baseline state model database 330 may have stored upon it a plurality of 3D models and/or feature baseline states of one or more monitored premises. Each baseline state model may comprise one or more of a 3D point cloud, areas and/or features to monitor, measurements of features, alert thresholds, etc. of the monitored premises. In some embodiments, the baseline state model may further include image sensor data such as visible and invisible (e.g. infrared, ultraviolet, thermal, night-vision, etc.) wavelength images. In some embodiments, the baseline state model may further include data associated stationary devices such one or more of a door sensor, a window sensor, a motion sensor, a security camera, a gas sensor, an appliance, etc.

In some embodiments, the baseline state models may be built based on an initial survey of the monitored premises. In some embodiments, the central computer 310 may be configured to update the baseline state model of a monitored premises location based on subsequent scans and/or user feedback. For example, if a new security camera is installed, the system may update the baseline model to include the location and/or orientation of the new security camera.

The UAV 320 may comprise an unmanned aerial vehicle configured to carry sensors and fly near monitored premises for data capture. In some embodiments, the UAV 320 may comprise a multicopter configured to hover at or near the monitored premises. For example, the UAV may be a quadcopter, or hexacopter, octocopter, etc. In some embodiments, the UAV 320 may be the UAV 120 in FIG. 1. The UAV 320 includes a control circuit 321, motors 322, a GPS sensor 323, a long range transceiver 325, a short range transceiver 326, a 3D scanner 327, and an image sensor 328.

The control circuit 321 may comprise one or more of a processor, a microprocessor, a microcontroller, and the like. The control circuit 321 may be communicatively coupled to one or more of the motors 322, the GPS sensor 323, the long range transceiver 325, the short range transceiver 326, the 3D scanner 327, and the image sensor 328. Generally, the control circuit 321 may be configured to navigate the UAV 320 based on instructions received form the central computer 310 and cause the sensors to gather a set of data at the monitored premises. In some embodiments, the UAV 320 may include separate control circuits for controlling the navigation of the UAV 320 and operating at least some of the sensor devices carried by the UAV 320.

The motors 322 may be motors that control one or more of a speed and/or orientation of one or more propellers on the UAV 320. The motors 322 are configured to be controlled by the control circuit 321 to lift and steer the UAV 320 in designated directions. The GPS sensor 323 may be configured to provide a GPS coordinate to the control circuit 321 for navigation. In some embodiments, the UAV 320 may further include an altimeter for providing altitude information to the control circuit 321 for navigation. Generally, the UAV may use the GPS and the altimeter readings to stay on a predetermined route to and from a monitored premises. In some embodiments, the UAV may further include short-range navigation sensors for avoiding collisions with obstacles in the path of the travel.

The long range transceiver 325 may comprises one or more of a mobile data network transceiver, a satellite network transceiver, a WiMax transceiver, and the like. Generally, the long range transceiver 325 is configured to allow the control circuit 321 to communicate with the central computer 310 while the UAV 320 is in flight and/or at monitored premises. In some embodiments, the central computer 310 maintains communication with the UAV 320 as the UAV 320 travels to the monitored premises and collect data.

The short range transceiver 326 may comprise one or more of a Wi-Fi transceiver, a Bluetooth transceiver, a RFID reader, and the like. Generally, the short range transceiver 326 has a range of several feet and is configured to allow the control circuit 321 to communicate with one or more on-premises devices at the monitored premises. The monitored premises may include one or more stationary devices such a door sensor, a window sensor, a motion sensor, a security camera, a gas sensor, and an appliance. In some embodiments, the one or more on-premises devices may be initially placed by a UAV, a service personnel, and/or a service subscriber. The control circuit 321 may retrieve data from the stationary devices via the short range transceiver 326. In some embodiments, the collected data may comprise a history of data recorded over time. In some embodiments, the control circuit 321 may be configured to activate a stationary device to begin data collection/transmission via the short range transceiver 326. In some embodiments, the stationary devices may communicate directly with the central computer 310 via the internet.

The 3D scanner 327 generally comprises a scanner configured to generate a 3D point cloud of at least part of its surroundings. The 3D scanner 327 may comprise a large volume 3D laser scanner such as a Faro Focus3D scanner. In some embodiments, the 3D scanner 327 may be configured to measure the distance between the scanner and a plurality of points in its surrounding to obtain a 3D point cloud of its surroundings. The 3D scanner 327 may include an actuator for pointing the laser at different angles around the scanner. In some embodiments, the distance measurement may be obtained from repeated measurements of reflected laser at different angles. In some embodiments, the central computer 310 and/or the 3D scanner 327 may stitch point clouds captured at different locations and/or perspectives to form a 3D point cloud of the premises.

The image sensor 328 may comprise visible and/or invisible light spectrum image sensors. In some embodiments, the image sensor 328 may comprise a 2D image sensor such as a colored image camera and/or a thermal image sensor. In some embodiments, the image sensor 328 may capture images from the same perspectives as the 3D scanner to correlate the distance measurements made by the 3D scanner with the image information captured by the image sensor 328.

While only one UAV 320 is shown, in some embodiments, the central computer 310 may communicate with and/or control a plurality of UAVs. In some embodiments, two or more UAVs may be deployed to monitor the premises location at the same time. For example, two or more UAVs may perform 3D scans of the same premises from different angels and locations. In some embodiments, two or more UAVs may monitor one or more premises in shifts. In some embodiments, the UAV 320 and/or a similar UAV may be dispatched to perform an initial survey of the premises to establish a baseline condition model of the monitored premises.

In some embodiments, one or more of the short range transceiver 326 and the image sensor 328 may be optional to at least some UAVs in the system. In some embodiments, one or more of the 3D scanner 327 and the image sensor 328 may be part of a sensor device controlled by a separate control circuit. The sensor device may communicate with the control circuit 321 via a local connection and/or the central computer 310 via the long range transceiver 325 and/or a separate transceiver. In some embodiments, the data collected by one or more of the 3D scanner 327 and the image sensor 328 may be communicated back to the central computer 310 substantially in real-time. The central computer 310 may use the collected data to determine further instructions for the UAV 320 at the monitored premises. In some embodiments, the data collected by one or more of the 3D scanner 327 and the image sensor 328 may be stored on a memory device on the UAV 320 and transferred to the central computer 310 at a later time.

In some embodiments, the UAV 320 may further include other flight sensors such as optical sensors and radars for detecting obstacles in the path of flight. In some embodiments, one or more of the 3D scanner 327 and the image sensor 328 may also be used as navigation sensors.

Referring now to FIG. 4, a process for monitoring premises according to some embodiments is shown. In step 411, a customer provides initial information via a customer interface application. While a customer interface application is shown in FIG. 4, the user interface may generally be provided via one or more of a web-accessible interface, a mobile application, a computer program, and the like. The initial information may include premises location, monitoring schedule, monitoring options, user authentication information, etc. In step 421, a satellite image of a requested premises is obtained. In step 431, the central computer determines surveillance boundary and parameters of the premises. The surveillance boundary and parameters may be based on the information entered in step 411 and other premises information such as property record, satellite image obtained in step 421, zoning restrictions, etc.

In step 432, UAVs are dispatched to the monitored premises. In step 441, the UAVs fly over and through the property, perform a 3D scan, and collect images and data from the monitored premises. In some embodiments, one or more UAVs may perform step 432 at a time. In step 435, measurements, videos, and 3D scan data are recorded at the central computer. In step 414, the captured data and images may be made available for playback to the user via the user interface. In step 434, the central computer creates a map and/or model of the monitored premises based on the collected data. In step 413, the maps and models may be made available for viewing by the user via the user interface.

In step 433, the system performs analyze and assessment of security elements based on the collected data. In some embodiments, the analysis may be based on comparing the collected data with a baseline state model of the premises. In step 412, the alert(s) generated based on the analysis in step 433 may be made available to users via the customer interface application. After step 433, the process may return to step 432 for a subsequent security monitoring UAV dispatch.

In one embodiment, a system for monitoring premises comprises: an unmanned aerial vehicle (UAV) comprising a three dimension (3D) scanner, a baseline model database, and a control circuit comprising a communication device for communicating with the UAV. The control circuit being configured to: instruct the UAV to travel to monitored premises and perform a 3D scan with the 3D scanner to obtain a 3D point cloud of the monitored premises, retrieve a baseline state model of the monitored premises from the baseline model database, the baseline state model comprises a baseline state of one or more features of the monitored premises, compare a current state of the one or more features in the 3D point cloud of the monitored premises with the baseline state of the one or more features in the baseline state model, and identify a deviation of the current state of the one or more features of the monitored premises from the baseline state.

In one embodiment, a method for monitoring premises comprises: instructing, with a control circuit, an unmanned aerial vehicle (UAV) comprising a three dimension (3D) scanner to travel to monitored premises and perform a 3D scan with the 3D scanner to obtain a 3D point cloud of the monitored premises, retrieving a baseline state model of the monitored premises from a baseline model database, the baseline state model comprises a baseline state of one or more features of the monitored premises, comparing, with the control circuit, a current state of the one or more features in the 3D point cloud of the monitored premises with the baseline state of the one or more features in the baseline state model, and identifying a deviation of the current state of the one or more features of the monitored premises from the baseline state.

In one embodiment, an apparatus for monitoring premises comprises a non-transitory storage medium storing a set of computer readable instructions and a control circuit configured to execute the set of computer readable instructions which causes to the control circuit to: instruct an unmanned aerial vehicle (UAV) comprising a three dimension (3D) scanner to travel to monitored premises and perform a 3D scan with the 3D scanner to obtain a 3D point cloud of the monitored premises, retrieve a baseline state model of the monitored premises from a baseline model database, the baseline state model comprises a baseline state of one or more features of the monitored premises, compare, with the control circuit, a current state of the one or more features in the 3D point cloud of the monitored premises with the baseline state of the one or more features in the baseline state model, and identify a deviation of the current state of the one or more features of the monitored premises from the baseline state.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for monitoring premises, comprising:
an unmanned aerial vehicle (UAV) comprising a three dimension (3D) scanner;
a baseline model database; and
a control circuit comprising a communication device for communicating with the UAV and configured to:
instruct the UAV to travel to monitored premises and perform a 3D scan with the 3D scanner to obtain a 3D point cloud of the monitored premises;
retrieve a baseline state model of the monitored premises from the baseline model database, the baseline state model comprises a baseline state of one or more features of the monitored premises;
compare a current state of the one or more features in the 3D point cloud of the monitored premises with the baseline state of the one or more features in the baseline state model; and
identify a deviation of the current state of the one or more features of the monitored premises from the baseline state.

2. The system of claim 1, wherein the UAV further comprises an image sensor, and the current state of the one or more features are determined based on data captured by one or more of the 3D scanner and the image sensor.

3. The system of claim 2, wherein the image sensor comprises one or more of: a color image sensor and a thermal image sensor.

4. The system of claim 1, wherein the one or more features of the monitored premises comprise one or more of: a door, a gate, a window, an electrical box, and a security camera.

5. The system of claim 1, wherein the baseline state of the one or more features of the monitored premises comprises one or more of a gap width between a door and a door frame, a gap width between door panels, a gap width between a window and a window frame, and a gap width between window panels.

6. The system of claim 1, wherein the baseline state of the one or more features of the monitored premises comprises one or more of a presence and an orientation of a security camera.

7. The system of claim 1, wherein the control circuit is further configured to instruct the UAV or a second UAV to travel to the monitored premises and perform a 3D scan to obtain a 3D point cloud to form the baseline state model.

8. The system of claim 1, wherein the UAV further comprises a short-range wireless communication device configured to communicate with one or more stationary devices on the monitored premises.

9. The system of claim 8, wherein the one or more stationary devices comprise one or more of a door sensor, a window sensor, a motion sensor, a security camera, a gas sensor, and an appliance.

10. The system of claim 1, wherein the control circuit is further configured to generate a security improvement recommendation based on one or more of the baseline state model and the 3D point cloud of the monitored premises.

11. The system of claim 1, wherein the control circuit is further configured to generate an alert to a user based on the deviation of the current state of the current state of the one or more features of the monitored premises.

12. A method for monitoring premises, comprising:
instructing, with a control circuit, an unmanned aerial vehicle (UAV) comprising a three dimension (3D) scanner to travel to monitored premises and perform a 3D scan with the 3D scanner to obtain a 3D point cloud of the monitored premises;
retrieving a baseline state model of the monitored premises from a baseline model database, the baseline state model comprises a baseline state of one or more features of the monitored premises;
comparing, with the control circuit, a current state of the one or more features in the 3D point cloud of the monitored premises with the baseline state of the one or more features in the baseline state model; and
identifying a deviation of the current state of the one or more features of the monitored premises from the baseline state.

13. The method of claim 12, wherein the UAV further comprises an image sensor, and the current state of the one or more features are determined based on data captured by one or more of the 3D scanner and the image sensor.

14. The method of claim 13, wherein the image sensor comprises one or more of: a color image sensor and a thermal image sensor.

15. The method of claim 12, wherein the one or more features of the monitored premises comprise one or more of: a door, a gate, a window, an electrical box, and a security camera.

16. The method of claim 12, wherein the baseline state of the one or more features of the monitored premises comprises one or more of a gap width between a door and a door frame, a gap width between door panels, a gap width between a window and a window frame, and a gap width between window panels.

17. The method of claim 12, wherein the baseline state of the one or more features of the monitored premises comprises one or more of a presence and an orientation of a security camera.

18. The method of claim 12, further comprising: instructing the UAV or a second UAV to travel to the monitored premises and perform a 3D scan to obtain a 3D point cloud to form the baseline state model.

19. The method of claim 12, wherein the UAV further comprises a short-range wireless communication device configured to communicate with one or more stationary devices on the monitored premises.

20. The method of claim 19, wherein the one or more stationary devices comprise one or more of a door sensor, a window sensor, a motion sensor, a security camera, a gas sensor, and an appliance.

21. The method of claim 12, further comprising: generating a security improvement recommendation based on one or more of the baseline state model and the 3D point cloud of the monitored premises.

22. The method of claim 12, further comprising: generating an alert to a user based on the deviation of the current state of the current state of the one or more features of the monitored premises.

23. An apparatus for monitoring premises, comprising:
a non-transitory storage medium storing a set of computer readable instructions; and
a control circuit configured to execute the set of computer readable instructions which causes to the control circuit to:
instruct an unmanned aerial vehicle (UAV) comprising a three dimension (3D) scanner to travel to monitored premises and perform a 3D scan with the 3D scanner to obtain a 3D point cloud of the monitored premises;
retrieve a baseline state model of the monitored premises from a baseline model database, the baseline state model comprises a baseline state of one or more features of the monitored premises;
compare, with the control circuit, a current state of the one or more features in the 3D point cloud of the monitored premises with the baseline state of the one or more features in the baseline state model; and identify a deviation of the current state of the one or more features of the monitored premises from the baseline state.
